(19) United States
(12) Patent Application Publication
(10) Pub. No.: US 2005/0273585 A1
(43) Pub. Date: Dec. 8, 2005

(54) System and method associated with persistent reset detection

(76) Inventor: Phillip Andrew Leech, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/863,053

(22) Filed: Jun. 8, 2004

(51) Int. Cl. G06F 15/177

(52) U.S. Cl. 713/1

(57) ABSTRACT

Systems, methodologies, media, and other embodiments associated with detecting and/or reacting to a persistent reset state are described. One exemplary method embodiment includes analyzing a reset signal and a power good signal and a timing relationship between their (de)assertions. The example method may also include generating a signal related to detecting a persistent reset condition.

### BACKGROUND

Computers may be turned off and on. Similarly, computers may be reset. Resetting a computer may include initializing various components, establishing various logical and/or physical states in the computer, establishing communications between various components, and so on. Resetting a computer may also include controlling and/or monitoring various signals produced by and/or associated with the computer. These signals may have various timing relationships between them. For example, a second reset action may not proceed until a first reset action has concluded and indicated its conclusion by (de)asserting a signal.

Computers may include various components like processors, data busses, disks, memory and so on. Some of these components may be specialized like a North Bridge, a South Bridge, a Super I/O (input/output), and so on. One type of computer is a blade computer. A blade computer may include, for example, a thin rectangular circuit board on which components like a processor, hard drive, memory, and so on, are located. A blade computer may include specialized components like a South Bridge. The South Bridge may be involved in actions like resetting, booting, and so on. Thus, the South Bridge may establish, evaluate, monitor, and so on, various signals associated with resetting, booting, and the like.

A blade computer may be associated with (e.g., housed in) an enclosure. The enclosure may include an enclosure manager that is configured to manage the enclosure and/or the blade computers associated with the enclosure. The enclosure manager may be, for example, a computer (e.g., PowerPC based computer). Since the enclosure manager may communicate with blade computers, the enclosure manager may include hardware, firmware, software, and so on configured to facilitate these communications. One thing communicated between a blade computer and the enclosure manager may be error messages. For example, a “blade too hot” error message may be communicated from a blade computer to an enclosure manager. The enclosure manager may then be configured to take various actions based on the error message. By way of illustration, in response to a “blade too hot” error message, the enclosure manager may reconfigure air moving apparatus.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example method associated with selectively generating a persistent reset signal.

FIG. 2 illustrates an example method associated with detecting a persistent reset condition.

FIG. 3 illustrates an example method associated with generating a persistent reset state signal.

FIG. 4 illustrates an example system associated with producing a signal concerning a persistent reset condition.

FIG. 5 illustrates an example logic associated with detecting and reporting a persistent reset state.

FIG. 6 illustrates an example timing diagram associated with detecting a persistent reset state.

FIG. 7 illustrates a portion of an example blade computer.

### DETAILED DESCRIPTION

As described above, computers may be reset. Resetting a computer may include asserting and de-asserting various signals according to certain desired timing schedules. In some cases, a reset signal may not be de-asserted in a timely fashion. Conventionally, some computers like blade computers configured with a North Bridge, South Bridge, Super I/O chipset may not handle a reset signal not being de-asserted in a timely fashion. Thus, example systems and methods may facilitate detecting a persistent reset condition where a reset signal may be asserted for an inappropriate period of time and/or at an inappropriate point in time. Additionally, example systems and methods may facilitate producing a signal related to the persistent reset condition.

The following includes definitions of selected terms employed herein. The definitions include various examples and/or forms of components that fall within the scope of a term and that may be used for implementation. The examples are not intended to be limiting. Both singular and plural forms of terms may be within the definitions.

The term South Bridge refers generally to a part of a computer chipset that facilitates connecting slower speed devices and/or interfaces (e.g., parallel, serial, Universal Serial Bus (USB)) to a North Bridge and thus to a central processing unit (processor). Different chipset manufacturers may implement different South Bridge logics, and thus the term South Bridge is intended to include those various implementations. A South Bridge may be operably connected to a Super I/O that is in turn operably connected to various other devices. The term Super I/O refers generally to a part of a computer chipset that facilitates connecting devices like a serial port, a parallel port, a floppy disk, and so on, to a South Bridge. Different chipset manufacturers may implement different Super I/O logics, and thus the term Super I/O is intended to include those various implementations. The term North Bridge refers generally to a part of a computer chipset that facilitates connections between a processor and interfaces to other parts of a computer like the computer memory, advanced graphics processor(s), various busses, and so on. The North Bridge is typically operably connected to the South Bridge. Different chipset manufacturers may implement different North Bridge logics, and thus the term North Bridge is intended to include those various implementations. Some chipset manufacturers may organize various functions associated with a chipset into different logics and/or may refer to South Bridge and North Bridge type logics as a GMCH (Graphics and Memory Controller Hub), an ICH (I/O Controller Hub), and so on. Thus, the terms South Bridge and North Bridge are intended to include these logics.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device (PLD), a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically and/or statically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may depend, for example, on requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein may be produced using programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

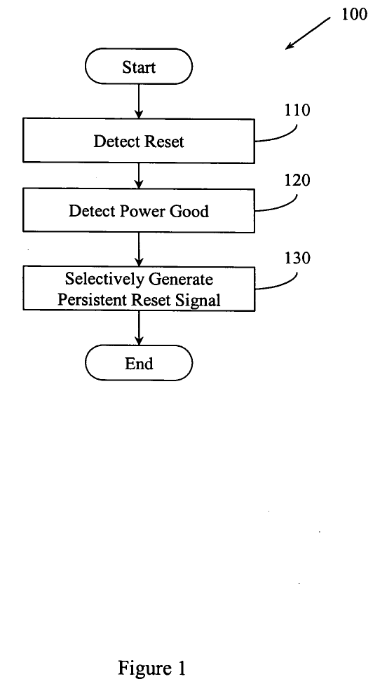

Example methods may be better appreciated with reference to the flow diagrams of FIGS. 1 through 3. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. The processing blocks may represent a method step and/or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 1 illustrates an example method 100 associated with selectively generating a persistent reset signal. The persistent reset signal may be generated in response to detecting a persistent reset condition. The persistent reset condition may occur, for example, when a reset signal remains asserted after it should have been de-asserted in a computer reset and/or boot process. The reset signal may initially be asserted, for example, during a reset process in a computer. The computer may include a chipset that includes, for example, a South Bridge, a North Bridge, and a Super I/O. Thus, in one example, the reset signal may be asserted by a South Bridge in a blade computer. While a South bridge and a blade computer are described, it is to be appreciated that other logics associated with other computers may assert the reset signal.

The method 100 may include, at 110, detecting that a reset signal associated with a computer reset process is asserted. The reset signal may be asserted to facilitate resetting the computer. Resetting the computer may include producing certain states, in certain orders, in certain logics in the computer. Thus, the method 100 may also include, at 120, detecting that a power good signal is asserted in response to the reset signal being asserted. Having the power good signal asserted may indicate that a reset process is proceeding in a desired manner. Thus, in response to the power good signal being asserted in a desired time period, the logic that asserted the reset signal may de-assert the reset signal. However, if the reset signal is not timely de-asserted, then the persistent reset condition and/or state may exist. Therefore, the method 100 may include, at 130, selectively generating a persistent reset signal based on determining whether the reset signal is de-asserted within a pre-determined period of time measured from when the power good signal being asserted is detected.

A power good signal is a signal provided, for example, to a logic like a South Bridge to indicate that various computer components have entered a desired state in the reset process and that the logic may begin communicating with another logic like a North Bridge. In one example, the power good signal may be the PWG signal provided by a Super I/O to a South Bridge in a blade computer. Thus, in one example, the power good signal is asserted by a Super I/O component associated with the computer to indicate that the South Bridge may communicate with other components associated with the computer. In the example, the South Bridge de-asserting the reset signal may control whether the computer will leave the reset state and enter a boot state.

While FIG. 1 illustrates various actions occurring in serial, it is to be appreciated that various actions illustrated in FIG. 1 could occur substantially in parallel. By way of illustration, a first process could detect reset signal values and/or state changes. Similarly, a second process could detect power good signal values and/or state changes, while a third process could selectively generate a persistent reset signal. While three processes are described, it is to be appreciated that a greater and/or lesser number of processes could be employed and that lightweight processes, regular processes, threads, and other approaches could be employed. It is to be appreciated that other example methods may, in some cases, also include actions that occur substantially in parallel. Furthermore, it is to be appreciated that method 100 may implemented by a logic like a programmable logic device.

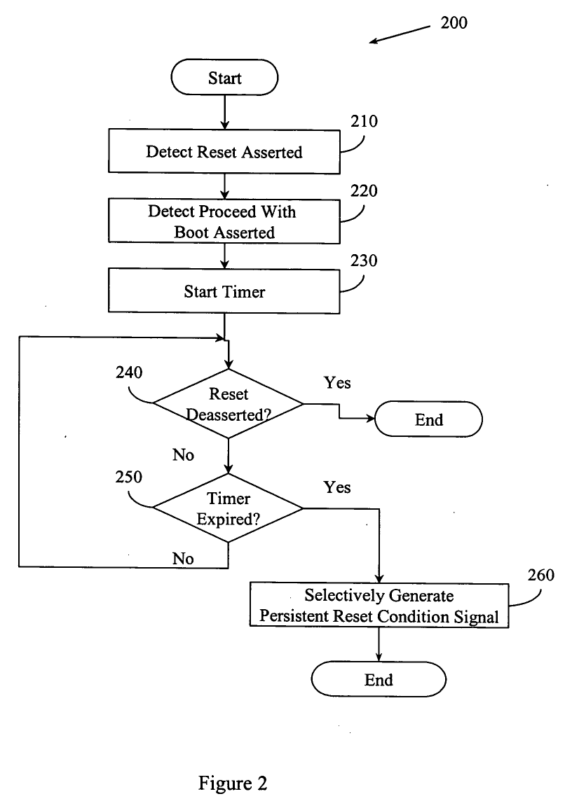

FIG. 2 illustrates a method 200 for detecting a persistent reset condition. After detecting the persistent reset condition, method 200 may, for example, respond to the condition by producing a signal concerning the condition. The method 200 may include, at 210, detecting that a reset signal has been asserted by a South Bridge associated with a blade computer. Asserting the reset signal indicates that the South Bridge is attempting to reset the blade computer so that a boot process may begin. Thus, the method 200 may also include, at 220, detecting that a proceed with boot signal has been asserted by a Super I/O component associated with the blade computer in response to the reset signal. The proceed with boot signal may be, for example, a power good signal provided to the South Bridge by the Super I/O. Once the proceed with boot signal is detected, the method 200 may include, at 230, starting a timer. The timer may be configured to expire after a first time period. For example, a first chipset may expect that the reset signal will be de-asserted within two milliseconds of detecting a power good signal. Thus, starting the timer may facilitate determining whether the South Bridge de-asserts the reset signal within a desired time period. If the South Bridge does not de-assert the reset signal within a desired time period, then the reset process may not be proceeding as desired, and actions like aborting the reset process, restarting the reset process, and so on, may be undertaken.

Thus, the method 200 may include, at 240, determining whether the reset signal has been de-asserted. If the reset signal has been de-asserted, and the timer has not yet expired, then the reset process may be proceeding in a desired manner and method 200 may terminate. However, if at 240 it is determined that the reset signal has not been de-asserted (e.g., is still asserted), then at 250 a determination may be made concerning whether the timer has expired. If the determination at 250 is Yes, then at 260, a persistent reset condition signal may be generated. However, if the determination at 250 is No, that the timer has not expired, then the method 200 may continue checking for the reset signal to be de-asserted. While a looping flow is illustrated in FIG. 2, it is to be appreciated that other logical flows that facilitate analyzing the point in time when the reset signal is de-asserted may be employed.

In one example, method 200 may include controlling an illumination state of a light emitting diode (LED) associated with the blade computer based, at least in part, on determining whether the reset signal has been de-asserted before the timer expires. Thus, a user may be informed of the state of a reset process, and thus the health of a blade computer, by an LED color. While an LED is described, it is to be appreciated that other apparatus for displaying the state of a reset process and/or the health of a blade computer may be controlled, at least in part, by method 200.

In another example, method 200 may provide the persistent reset condition signal to a supervising apparatus like an enclosure manager in which the blade computer is arranged. The enclosure manager may be configured to control, for example, the blade computer and/or an enclosure in which the blade computer is located. Controlling the blade computer and/or an enclosure in which the blade computer is located may include, for example, providing power to a computer, managing air conditioning apparatus associated with a computer or enclosure, reporting computer status, logging computer actions, and the like.

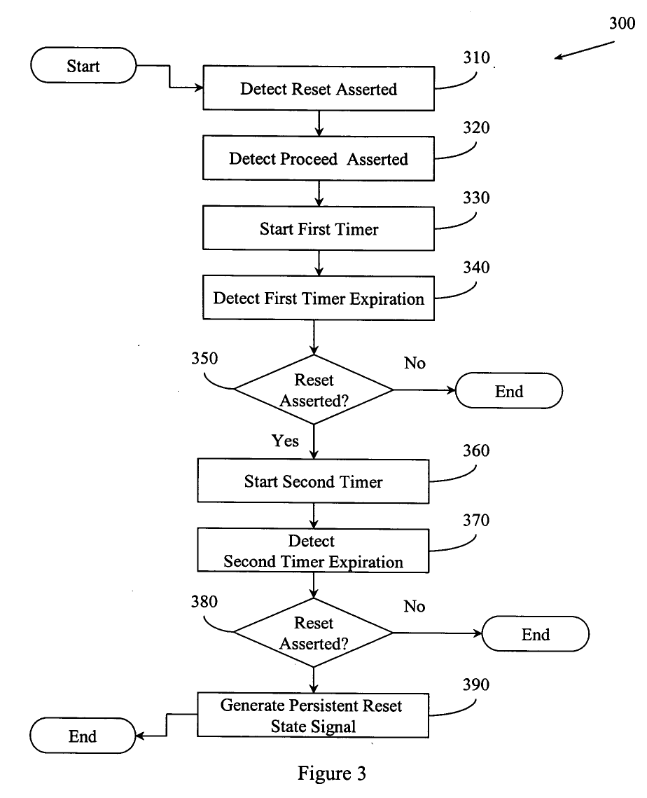

FIG. 3 illustrates a method 300 for generating a persistent reset state signal. The persistent reset state signal may be generated in response to detecting a persistent reset state in, for example, a blade computer configured with a North Bridge, South Bridge, Super I/O chipset. The method 300 may include, at 310, detecting when a reset signal is asserted by a first logic that is configured to facilitate resetting a computing system. The first logic may be, for example, a South Bridge. The method 300 may also include, at 320, detecting when a proceed signal is asserted by a second logic that is configured to facilitate resetting the computing system. In one example, the second logic may be a Super I/O.

At 330, a first timer is started when the proceed signal is detected. At 340, the expiration of the first timer is detected. The first timer may have been programmed to run for a first configurable period of time related to determining whether a reset process is occurring in a desired manner and thus, at 350, a determination is made concerning whether the reset signal is still asserted. If the determination at 350 is No, that the reset signal is not asserted, then the method 300 may conclude because the reset signal is de-asserted and not in a “stuck reset” or persistent condition.

If the determination at 350 is Yes, that the reset signal is still asserted, then at 360 a second timer may be started. The second timer may be configured to run for a second configurable period of time. The second period of time may be different in different chipset configurations. However, the second period of time should provide a designer with a confidence level that if the reset signal is still asserted after the second timer expires, then an error condition likely exists and some remedial action may be desired. The second period of time may be related to and determined, at least in part, by the first configurable period of time. Thus, at 370, the expiration of the second timer is detected. At 380, upon determining that the second timer has expired and that the reset signal is no longer asserted, the method 300 may conclude. However, if the second timer expires and the reset signal is still asserted, then at 390 a persistent reset state signal may be generated.

In one specific example, the first timer may be configured to run for between one and three milliseconds. In the specific example, the second timer may be configured to run for more than two seconds. In a more general example, the first timer may be configured to run for a first configurable period of time and the second timer may be configured to run for a second configurable period of time that is related to the first configurable period of time. Thus, in the more general example, the time out condition associated with a persistent reset condition may depend on a system power to reset de-assertion timing.

In one example, methodologies are implemented as processor executable instructions and/or operations provided on a computer-readable medium. Thus, in one example, a computer-readable medium may store processor executable instructions operable to perform a method for detecting when a reset signal is asserted by a reset logic configured to facilitate resetting a computing system and for detecting when a proceed signal is asserted by a proceed logic configured to facilitate resetting the computing system. The method may also include starting a first timer when the proceed signal is detected, the first timer being programmable to run for a first configurable period of time and starting a second timer that is programmable to run for a second configurable period of time if the first timer expires and the reset signal is still asserted. Upon determining that the second timer has expired and that the reset signal is still asserted, the method may include generating the persistent reset condition signal. While the above method is described being provided on a computer-readable medium, it is to be appreciated that other example methods described herein can also be provided on a computer-readable medium. These methods may then be implemented in, for example, a discrete logic like a programmable logic device. Since the methods concern detecting and/or reacting to a condition associated with resetting and/or booting a computer, a processor may not be available to execute processor executable instructions. Thus, the methods may be implemented in a discrete logic.

There may be a relationship between the first configurable period of time and the second configurable period of time. In one example, the first configurable period of time may be about two milliseconds and the second configurable period of time may be about three seconds. More generally, the second configurable period of time may be a function of the first configurable time. For example, the second configurable time may be about one order of magnitude larger than the first configurable period of time. It is to be appreciated that different logics (e.g., South Bridges, North Bridges, Super I/Os) may have various timing relationships and thus the relationship between the first configurable period of time and the second configurable period of time may depend on the various timing relationships.

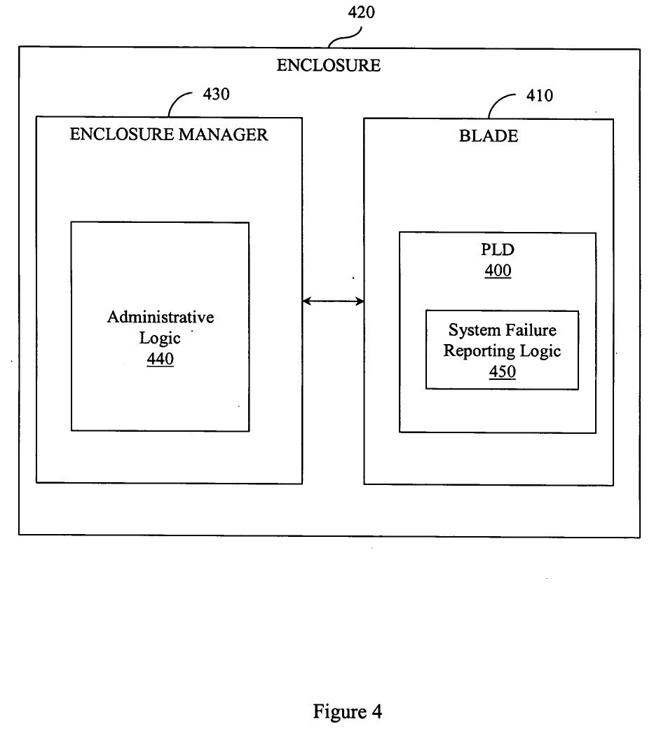

FIG. 4 illustrates a programmable logic device (PLD) 400 that is configured to provide a signal related to a persistent reset condition. The PLD 400 may be located, for example, in a blade computer 410 that is located in an enclosure 420. The term enclosure refers generally to an apparatus that encloses (e.g., houses, provides power for, controls), completely and/or incompletely, logically and/or physically a set of computers (typically blade computers). The enclosure 420 may include an enclosure manager 430 that manages (e.g., monitors power, monitors health, reports on health) the enclosure 420 and/or a set of computers (e.g., blade computers) operably connected to the enclosure 420. The enclosure manager 430 may include an administrative logic 440 that is configured to receive and/or react to the signal related to the persistent reset condition. By way of illustration, the administrative logic 440 may be configured to manipulate a state associated with the blade computer 410, to manipulate a light emitting diode associated with the blade computer 410, to generate a second signal associated with the persistent reset condition, and so on.

The PLD 400 may include a system failure reporting logic 450 that is configured to detect a persistent reset condition in blade computer 410 and to produce a signal related to the persistent reset condition. As described above, a persistent reset condition may occur when a reset process does not proceed in a desirable manner and a reset signal is not de-asserted within a desired time period.

The blade computer 410 may be operably connected to the enclosure manager 430 and thus the blade computer 410 may be configured to provide the signal related to the persistent reset condition to the enclosure manager 430. In one example, the blade computer 410 includes a chipset that includes a North Bridge, a South Bridge, and a Super I/O component. As part of a reset and boot process, the South Bridge may be configured to assert a reset signal and the super I/O component may be configured to assert a power good signal in response to the reset signal. Thus, the system failure reporting logic 450 may detect the persistent reset condition by determining whether the reset signal is de-asserted within a known time period after the power good signal is detected.

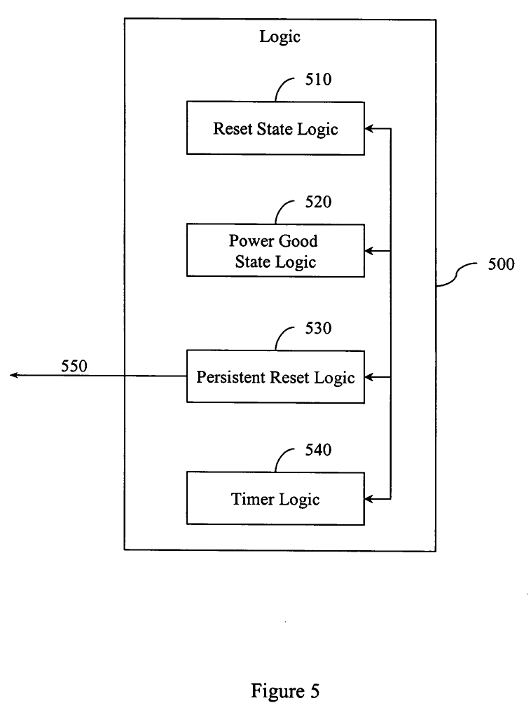

FIG. 5 illustrates a logic 500 that is configured to detect and report on a system failure like a persistent reset. The logic 500 may include a reset state logic 510 that is configured to detect a reset signal state. In one example, a reset signal in a computer may be controlled by a South Bridge associated with the computer. The computer may be, for example, a blade computer. A voltage and/or voltage change on a reset line associated with the South Bridge may determine the state of the reset signal detected by the reset state logic 510.

The logic 500 may also include a power good state logic 520 that is configured to detect a power good signal state. In one example, the power good signal may be controlled by a Super I/O component associated with the computer. A voltage and/or voltage change on a power line associated with the Super I/O component may determine the state of the power good signal detected by the power good state logic 520.

The logic 500 may also include a persistent reset logic 530 that is operably connected to the reset state logic 510 and the power good state logic 520. The persistent reset logic 530 may be configured to receive a timing signal from a timer logic 540 and to determine whether a persistent reset condition exists in a computer based on a timing relationship between a first state change in the power good signal and a second state change in the reset signal. For example, the persistent reset logic 530 may be configured to determine whether a persistent reset condition exists by detecting, in association with the reset state logic 510, that a first reset signal state indicates that the reset signal has been asserted. The persistent reset logic 530 may then detect, in association with the power good state logic 520, that a first power good signal state indicates that the power good signal has been asserted. Then, the persistent reset logic 530 may determine that a known period of time has elapsed after detecting the first power good signal state and that the reset signal state has not changed to a de-asserted state. In one example, the persistent reset logic 530 may produce a signal 550 associated with having detected a persistent reset condition. The signal 550 may, for example, control an LED, be passed to another logic, and so on.

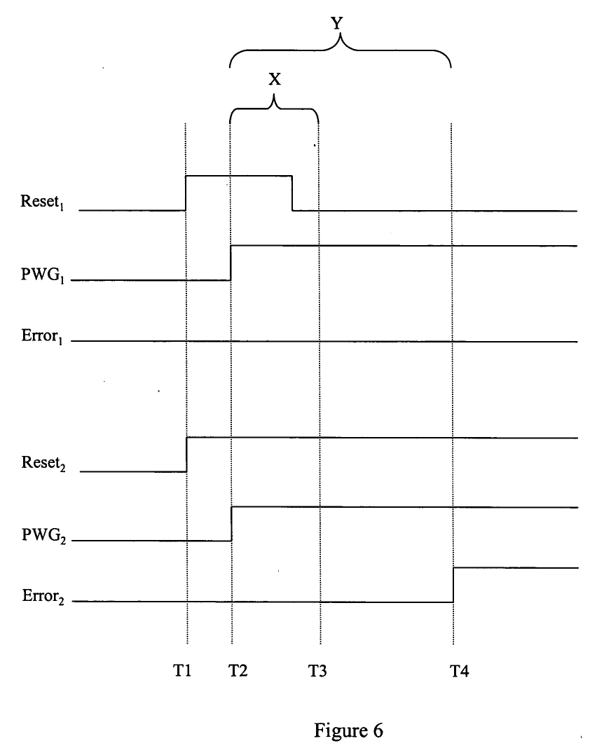

FIG. 6 illustrates a timing diagram associated with detecting a persistent reset condition in a computer reset process. The three signals at the top of the figure (Reset₁, PWG₁, Error₁) illustrate a desired timing sequence associated with the reset process. At time T1, the reset signal Reset₁ is asserted. This signal may be intended to put a computer in a reset state. Part of putting a computer in a reset state may include providing power to a set of computer components. When the power has been provided, a signal that indicates that the power has been provided may be produced. Thus, at time T2, the power good signal PWG₁ is asserted. In response to the PWG₁ signal being asserted, before time T3, the Reset₁ signal is de-asserted. De-asserting the Reset₁ signal may allow the reset process to continue and the computer may enter, for example, a boot state. The Reset₁ signal may need to be de-asserted within a time period X (e.g., between T2 and T3) to indicate that a reset process is proceeding in a desired fashion. If the Reset₁ signal is not de-asserted within a longer time period (e.g., Y (T2 to T4)), then an error signal may be asserted to indicate that a persistent reset condition exists. Since the Reset₁ signal was de-asserted, error signal Error₁ was not asserted. It is to be appreciated that “asserted” may include states like an active-high state, an active-low state, and so on. Thus, signal and/or state transitions illustrated in FIG. 6 are merely illustrative and low to high transitions, high to low transitions, and so on, may be employed with example systems and methods described herein.

In some cases, the desired timing illustrated in the top three signals in FIG. 6 may not be achieved. Instead, a sequence like that illustrated by the three signals at the bottom of the figure (e.g., Reset₂, PWG₂, Error₂) may be experienced. At time T1, the reset signal Reset₂ is asserted. Then at time T2, after power has been provided to a set of components, the power good signal PWG₂ is asserted. However, in the example, by time T3 the Reset₂ signal has not been de-asserted. T3 may coincide, for example, with the expiration of a first timer. By time T4, which coincides with the expiration of time period Y, the Reset₂ signal has still not been de-asserted. T4 may coincide, for example, with the expiration of a second timer. If the reset signal Reset₂ has not been de-asserted by T4, then the error signal Error₂ may be asserted to indicate that a persistent reset condition exists, to control a display device (e.g., LED), to signal an error processing logic, and so on.

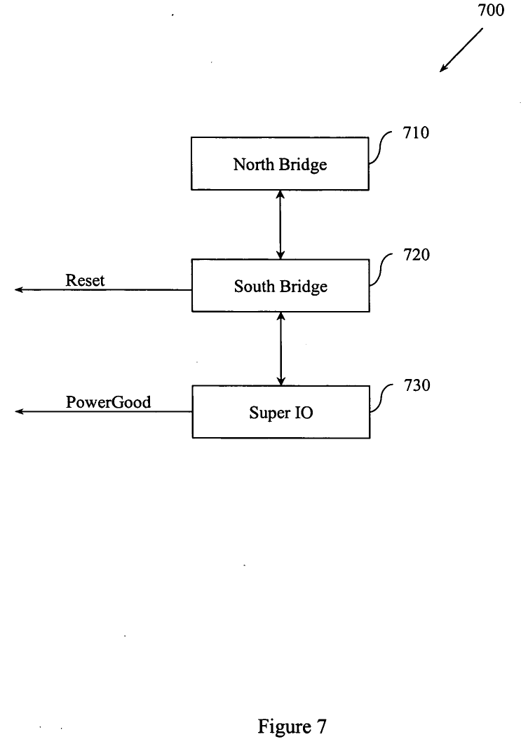

FIG. 7 illustrates one example arrangement of elements of a chipset 700. The chipset 700 may be associated, for example, with a blade computer. The chipset 700 may include, for example, a North Bridge 710, a South Bridge 720, and a Super I/O 730. The South Bridge 720 may produce, for example, a Reset signal and the Super I/O 730 may produce a PowerGood signal. The chipset 700 is one example set of computer components (e.g., logics) that may interact with the example systems and methods described herein. Therefore, whether implemented in hardware, firmware, software, and/or a combination of these, the chipset 700 may provide means for detecting a reset signal state, means for detecting a proceed with boot signal state and means for determining whether a persistent reset condition exists based on a timing relationship between a state change in the proceed with boot signal and a state change in the reset signal.

While example systems, methods, and so on, have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

1. A method, comprising:
detecting that a reset signal associated with a computer reset process is asserted;
detecting that a power good signal is asserted in response to the reset signal being asserted; and
selectively generating a persistent reset signal based on determining whether the reset signal is de-asserted within a pre-determined period of time measured from when the power good signal being asserted is detected.

2. The method of claim 1, where the reset signal is asserted by a South Bridge associated with a computer performing the computer reset process to place the computer into a reset state.

3. The method of claim 2, where the power good signal is asserted by a Super I/O component associated with the computer to indicate that the South Bridge may communicate with another component associated with the computer performing the computer reset process.

4. The method of claim 3, the computer comprising a blade computer.

5. The method of claim 4, where the South Bridge is configured to de-assert the reset signal to facilitate controlling whether the blade computer will leave the reset state and enter a boot state.

6. A computer-readable medium storing processor executable instructions operable to perform a method, the method comprising:
detecting that a reset signal associated with a computer reset process has been asserted, where the reset signal is asserted by a South Bridge associated with a blade computer performing the computer reset process to place the blade computer into a reset state;
detecting that a power good signal has been asserted in response to the reset signal, where the power good signal is asserted by a Super I/O component associated with the blade computer to indicate that the South Bridge may communicate with another component associated with the blade computer performing the computer reset process; and
selectively generating a persistent reset signal based on determining whether the reset signal is de-asserted within a pre-determined period of time measured from when the power good signal being asserted is detected.

7. A method for detecting a persistent reset condition, comprising:
detecting that a reset signal associated with a computer reset process has been asserted by a South Bridge associated with a blade computer performing the computer reset process;
detecting that a proceed with boot signal has been asserted by a Super I/O component associated with the blade computer in response to the reset signal being asserted;
starting a timer upon detecting that the proceed with boot signal has been asserted, where the timer is configured to expire after a first time period;
determining whether the reset signal has been de-asserted; and
selectively generating a persistent reset condition signal if the reset signal has not been de-asserted before the timer expires.

8. The method of claim 7, including controlling a light emitting diode associated with the blade computer based, at least in part, on the persistent reset condition signal being generated.

9. The method of claim 7, including providing the persistent reset condition signal to an enclosure manager configured to control, at least in part, the blade computer and an enclosure in which the blade computer is located.

10. The method of claim 7, the proceed with boot signal comprising a power good signal.

11. A method for generating a persistent reset state signal, comprising:
detecting when a reset signal associated with a computer reset process is asserted by a first logic configured to facilitate resetting a computing system;
detecting when a proceed signal is asserted by a second logic configured to facilitate resetting the computing system;
starting a first timer when the proceed signal is detected, the first timer being configured to expire after a first time period;
starting a second timer if the first timer expires and the reset signal is still asserted, the second timer being configured to expire after a second time period; and
upon determining that the second timer has expired and that the reset signal is still asserted, generating the persistent reset state signal.

12. The method of claim 11, the first logic comprising a South Bridge.

13. The method of claim 12, the computing system comprising a blade computer.

14. The method of claim 11, the proceed signal comprising a power good signal.

15. The method of claim 14, the second logic comprising a Super I/O.

16. The method of claim 11, the first timer being configured to expire after two milliseconds.

17. The method of claim 16, the second timer being configured to expire after two seconds.

18. The method of claim 11, where the first timer is configured to expire after a user configurable period of time.

19. The method of claim 18, the second timer being configured to expire after a second period of time, the second period of time being related to and determined, at least in part, by the user configurable period of time.

20. A computer-readable medium storing processor executable instructions operable to perform a method for generating a persistent reset state signal, the method comprising:
detecting when a reset signal associated with a computer reset process is asserted by a reset logic configured to facilitate resetting a computing system;
detecting when a proceed signal is asserted by a proceed logic configured to facilitate resetting the computing system;
starting a first timer when the proceed signal is detected, the first timer being programmable to run for a first configurable period of time;
if the first timer expires and the reset signal is still asserted, starting a second timer that is programmable to run for a second configurable period of time; and
upon determining that the second timer has expired and that the reset signal is still asserted, generating the persistent reset state signal.

21. A system, comprising:
a logic configured to detect a persistent reset condition in a blade computer and to produce a signal related to the persistent reset condition; and
a blade computer configured to be operably connected to an enclosure manager, the blade computer being configured with the logic, the blade computer being configured to provide the signal related to the persistent reset condition to the enclosure manager.

22. The system of claim 21, the logic being implemented in a programmable logic device.

23. The system of claim 22, where the blade computer includes a North Bridge, a South Bridge, and a Super I/O component, where, as part of a reset and boot process, the South Bridge is configured to assert a reset signal, and the Super I/O component is configured to assert a power good signal in response to the reset signal.

24. The system of claim 23, where the logic detects a persistent reset condition by determining whether the reset signal is de-asserted within a known time period after the power good signal is detected.

25. The system of claim 24, where the enclosure manager includes an administrative logic configured to receive the signal related to the persistent reset condition and to perform one or more of, manipulating a state associated with the blade computer, manipulating a display associated with the blade computer, and generating a second signal associated with the persistent reset condition.

26. A system, comprising:
a reset state logic configured to detect a reset signal state;
a power good state logic configured to detect a power good signal state; and
a persistent reset logic operably connected to the reset state logic and the power good state logic, the persistent reset logic being configured to receive a timing signal from a timer logic and to determine whether a persistent reset condition exists in a computer based on a timing relationship between a first state change in the power good signal and a second state change in the reset signal.

27. The system of claim 26, where a voltage on a reset signal line controlled by a South Bridge associated with a blade computer determines the reset signal state.

28. The system of claim 27, where a voltage on a power good signal line controlled by a Super I/O component associated with the blade computer determines the power good signal state.

29. The system of claim 28, where the persistent reset logic is configured to determine whether the persistent reset condition exists by detecting a first reset signal state that indicates that the reset signal has been asserted, detecting a first power good signal state that indicates that the power good signal has been asserted, and determining that a known period of time has elapsed after detecting the first power good signal state without the reset signal state changing to a de-asserted state.

30. A system, comprising:
means for detecting a reset signal state;
means for detecting a proceed with boot signal state; and
means for determining whether a persistent reset error condition exists based on a timing relationship between a state change in the proceed with boot signal and a state change in the reset signal.
